(19) United States
(12) Patent Application Publication
(10) Pub. No.: US 2007/0101907 A1
(43) Pub. Date: May 10, 2007

(54) Liner

(75) Inventor: Neil Christopher Hellmann, Elandsfontein (ZA)

Correspondence Address: BUCHANAN, INGERSOLL & ROONEY PC, POST OFFICE BOX 1404, ALEXANDRIA, VA, 22313-1404, US

(73) Assignee: CH CHEMICAL (PTY) LTD., Elandsfontein (ZA)

(21) Appl. No.: 10/561,591

(22) PCT Filed: Jun. 21, 2004
(86) PCT No.: PCT/IB04/02049

§ 371 Date: Feb. 23, 2006

(30) Foreign Application Priority Data
Jun. 20, 2003 (ZA) 2003/4815

(51) Int. Cl. C04B 24/00; C04B 28/14

(52) U.S. Cl. 106/776; 106/802; 524/3; 264/309

(57) ABSTRACT

A composition for use as a liner, in particular for preventing spalling of rock particles and falls of ground at rock excavation sites, for the lining of swimming pools or any other water proofing application such as concrete coating for corrosion and environmental damage protection is provided. The composition includes a water-based dispersion of polyurethane and a cementitious material. The cementitious material and the dispersion are mixed together to form a polymer concrete comprising an interpenetrating network of inorganic and organic polymers. Anhydrous calcium sulphate forms part of the cementitious material to improve the hardening and curing properties of the liner. Epoxy is a further component of the liner, thereby to improve the adhesion properties of the liner.

### BACKGROUND OF THE INVENTION

THIS invention relates to a polyurethane based liner.

In the mining industry it is common practice, following blasting, to line excavated rock with a skin of settable cementitious grout, which may or may not incorporate meshing and lacing as reinforcement. The grout is used primarily to improve the integrity of the wall structure and to inhibit the spalling of rock particles, particularly from the hanging walls between mine packs, roof bolts and other standard support systems. It is also of interest to line excavated rock, foundations, external walls and structures with a water proofing membrane to prevent damage to the structure by unwanted ingress of moisture.

Although it has been recognised that polyurethane liners could potentially be utilized in mining applications, polyurethanes have typically contained volatile organic compounds (VOCs). These VOCs may be released on application, when polyurethane is sprayed on to the rock surface, requiring protective equipment to be worn. More importantly, normal polyurethanes release toxic fumes upon combustion and, consequently, the use of such polyurethanes is not recommended in confined areas. These factors, coupled with the prohibitive costs normally associated with polyurethanes, relative to cementitious products, have prevented the use of polyurethane products in mining and waterproofing applications.

It is an object of the present invention to provide an alternative thin liner.

### SUMMARY OF THE INVENTION

According to the present invention, there is provided a method of forming a liner including the steps of mixing a water-based dispersion of polyurethane with a cementitious material to form a wet mixture and applying the wet mixture to a surface, to form the liner. On curing the liner forms a polymer concrete comprising an interpenetrating network of inorganic and organic polymers

Typically the % mass of the water-based dispersion of polyurethane in the wet mixture ranges between 40 and 80%, preferably the wet mixture ranges between 60 and 70% mass.

The water-based dispersion of polyurethane may include additives which improve the evaporation of liquid of the wet mixture, such as low boiling point alcohols, preferably isopropanol or ethanol, with a % mass in the wet mixture ranging between 0 to 5%.

Preferably, the cementitious material includes anhydrous calcium sulphate. The % mass in the wet mixture of the anhydrous calcium sulphate may range between 5 and 35%, 10 and 20% or preferably between 15 and 17%.

Typically, an epoxy hardener and an epoxy resin form part of the wet mixture, with the epoxy hardener being included in the water-based dispersion of polyurethane. The typical % mass of the epoxy hardener and epoxy resin is in the range of 1 to 10% and preferably in approximately 5%.

The epoxy resin may be mixed with a liquid carrier prior to being mixed with the epoxy hardener.

Typically, the liquid carrier is an amorphous precipitated silica.

The mixture between the epoxy resin and the liquid carrier is in powder form and is combined with the cementitious material.

The cementitious material may further include ordinary Portland or high alumina cement. It may further include an aggregate and/or chemical admixtures, such as hardening drying agents, flow drying agents, quick drying agents and water scavengers.

The cementitious material may also include concrete admixtures such as super plasticizers and accelerators, as well as additional fibrous material such as glass fibres or synthetic fibres. The fibrous material may further include organic fillers such as rubber crumb.

Optionally, the cementitious material may include sand, water and cement extenders.

Typically, the wet mixture is applied to a surface by spraying, rolling or brushing. The wet mixture is preferably sprayed in a fine mist onto the surface by a spray gun, the wet mixture applied to the surface having a thickness of between 0.1 to 5 mm. When rolled or brushed, the applied wet mixture typically has a thickness between 0.1 to 1.5 mm.

According to a second aspect of the invention a kit for the production of a wet mixture for forming a liner is disclosed. The kit includes a first component including a water-based dispersion of polyurethane and second component including a cementitious material.

Typically the % mass of the water-based dispersion of polyurethane in the wet mixture ranges between 40 and 80%, preferably the wet mixture ranges between 60 and 70% mass.

The first component may include additives which improve the evaporation of liquid of the wet mixture, such as low boiling point alcohols, preferably isopropanol or ethanol, with a % mass in the wet mixture ranging between 0 to 5%.

Preferably, the second component includes anhydrous calcium sulphate. The % mass in the wet mixture of the anhydrous calcium sulphate may range between 5 and 35%, 10 and 20% or preferably between 15 and 17%.

Typically, an epoxy hardener and an epoxy resin form part of the wet mixture, with the epoxy hardener being included in the water-based dispersion of polyurethane. The typical % mass of the epoxy hardener and epoxy resin is in the range of 1 to 10% and preferably is approximately 5%.

Preferably, the liquid epoxy resin is dispersed with a quantity of carrier, which may be an inert fine grade of silica, so as to adsorb the liquid onto the liquid carrier. This provides a means of ensuring homogenous dispersion of the epoxy resin adhesive.

The second component may further include ordinary Portland or high alumina cement It may further include an aggregate and/or chemical admixtures, such as hardening drying agents, flow drying agents, quick drying agents and water scavengers.

The second component may also include concrete admixtures such as super plasticizers and accelerators, as well as additional fibrous material such as glass fibres or synthetic fibres. The fibrous material may further include organic fillers such as rubber crumb.

Optionally, the second component may include sand, water and cement extenders.

According to a third aspect of the invention a wet mixture for forming a liner is provided, the wet mixture including a water-based dispersion of polyurethane and a cementitious material.

According to a fourth aspect of the invention there is provided a liner, the liner including a water-based dispersion of polyurethane and a cementitious material is provided.

### BRIEF DESCRIPTION OF THE DRAWINGS

FIG. 1 shows a graph of the tensile strength of the liner against the mass % of anhydrous calcium sulphate in the liner.

### DESCRIPTION OF PREFERRED EMBODIMENTS

Water based dispersions of polyurethanes are described in U.S. Pat. Nos. 5,688,842, 6,087,440, 5,539,021, 5,959,027, and 6,451,908 in the name of Dow Chemical Company, which do not contain dangerous volatile organic compounds (VOCs). These new generation polyurethane dispersions do not suffer from the toxicity concerns expressed above and contain approximately 56% polyurethane polymer and 44% water, by mass, and may be applied by air assisted spraying and air-dried.

These water-based dispersions of polyurethane can be used as thin layers of elastomers with exceptional strength and waterproofing properties, but the thickness of the layers are restricted. This is due to the fact that complete evaporation of water is necessary to ensure coagulation of the polymer.

The present invention relates to a liner formed by combining a water-based dispersion of polyurethane, such as the product SYNTEGRA™ developed by the Dow Chemical Company, with a cementitious material. Water in the dispersion is consumed during the curing reaction of the composition and forms a waterproof polymer concrete product having enhanced adhesive and physical properties when subjected to load conditions.

Important considerations for the use of a liner in these applications is its drying and curing properties. Cementitious materials may be selected from cements and calcium sulphate and other filler materials such as zeolites (aluminium/magnesium silicates) and diatomatious earth or bentonite clays with the water-based polyurethane dispersion. According to an aspect of the invention, it has been found that anhydrous calcium sulphate provides the best combination of dispersion properties (in the water-based polyurethane dispersion), high filler loading, physical properties (tensile strength, tear resistance and elongation) and curing properties. Anhydrous calcium sulphate as the cementitious material is the only component which, used in combination with the water-based polyurethane dispersion, does not produce cracks on the surface of the cured liner. These properties, as well as the waterproofing capability of the liner, are attributed to the interpenetrating network of inorganic and organic polymers formed by the combination of the water-based polyurethane dispersion with the cementitious material.

As the liner has improved properties when the evaporation of the water in the water-based polyurethane dispersion is accelerated during or after application of the liner, additives with a lower boiling point, i.e. having a boiling point below 50° C., have been included as components in the liner. Alcohols and/or isopropanols have been used as they form azeotropes with water and thus assist in the easy evaporation of the water component of the composition.

Although any type of water-based polyurethane dispersion can be used with the cementitious material, SYNTEGRA™ of the Dow Chemical company is preferred due to its high solid content However, due to the non-ionic nature of SYNTEGRA™, the adhesion properties of the liner had to be improved on. The adhesion properties are of particular importance where the liner is used to improve the integrity of the wall structure and to inhibit the spalling of rock particles in mines, as well as where used on concrete. It has been found that the addition of an epoxy improved the adhesion property of the liner, without having a notable impact on the other properties of the liner. Typically, an epoxy is a two-component thermoset material which comprises a resin which is mixed with a hardener to catalyse the curing thereof. An epoxy hardener has therefore been incorporated into the water-based polyurethane dispersion. The epoxy resin forms another component of the composition which is added separately. The hardener is typically a solvent free Polyamine adduct. Materials such as Polypox W 803 are dissolved in water and emulsifies the liquid epoxy resin in water. Polypox W803 is a water soluble solvent-free polyamine hardener with an amine number of 290 mgKOH/g, supplied by UPPC AG (D) giving excellent hardening in thick layers. Resins based on the reaction of bisphenol-a, bisphenol-f, novolac, cycloaliphatic or other epoxised materials or modifications thereof, can be utilised as the liquid resin component. CH Chemicals resin CHR-1, a reaction product of epichlorohydrin and bisphenol-A of epoxy equivalent 187 g/eq and % epoxide of 23% diluted in an organic solvent proved to give the appropriate results.

A kit for forming a liner is typically sold as a two component or three component product. In cases where adhesion of the liner is not crucial, the two component product comprises:
A water-based polyurethane dispersion containing isopropanol and/or ethanol, as well as additives such as antifoam, thickeners and additional water; and
Anhydrous calcium sulphate.

In cases where it is required that the liner has good adhesion properties a three component product comprises:
A water-based polyurethane dispersion containing isopropanol and/or ethanol, an epoxy hardener as well as additives such as antifoam, thickeners and additional water
Anhydrous calcium sulphate; and
An epoxy resin.

It has also been found that the components for the liner with good adhesion properties can be simplified by dispersing the liquid epoxy resin with a quantity of carrier, which may be an inert fine grade of silica. This carrier absorbs the liquid onto the liquid carrier and thereby provides a means of ensuring a homogenous dispersion of the epoxy resin adhesive. Typically, the epoxy resin is added to a liquid carrier such as Tixosil 38. Tixosil 38 is an amorphous precipitated silica used as a liquid carrier in the food industry. Without a liquid carrier, the mixture of anhydrous calcium sulphate and the epoxy resin forms a paste which is impossible to process. The Tixosil 38-epoxy resin mixture is used as a powder and is added to the anhydrous calcium sulphate component. The mixture of Tixosil 38-epoxy resin and anhydrous calcium sulphate is also in powder form, thereby constituting a two component product with good adhesion properties comprising:
A water-based polyurethane dispersion containing isopropanol and/or ethanol, an epoxy hardener as well as additives such as antifoam, thickeners and additional water
Anhydrous calcium sulphate and a Tixosil 38-epoxy resin mixture.

Typical ranges of the compositions used to form a liner in instances where adhesion is not critical, as well as an example of such a formulation, are provided below:

| | Typical Range | Example 1 | Typical |
|---|---|---|---|
| | Mass % | Mass % | Product Used |
| Polyurethane dispersion | 50-80 | 67.10 | Syntegra YM |
| | | | 2000 Dow |
| | | | Chemical |
| Anhydrous Calcium | 5-30 | 16.77 | |
| Sulphate | | | |
| Titanium dioxide | 0-10 | 4.83 | |
| Antifoam agent | 1-3 | 2.28 | |
| Water | 0-10 | 6.07 | |
| Thickener | 0-3 | 1.04 | |
| Iso-propanol | 0-5 | 1.91 | |

The antifoam additive is used in the composition to keep the sprayed, brushed or rolled material in an elastomeric form. A typical antifoam is AAG6 a synergistic blend of polyols, waxes, stearates and alcohols containing emulsifying agents. Titanium dioxide is a white powder that provides the liner with a white colour and also provides ultraviolet stabilisation properties to the liner. This component helps prevent the liner turning yellow under ultraviolet light. The thickener prevents the mixture from running down vertical surfaces after being applied. A typical thickener is Fume silica Wacker HDK N20.

Typical ranges of the compositions used to form a mixture applied as a liner where good adhesion properties on most substrates have been obtained, as well as an example of such a formulation, are provided below:

| | Typical Range | Example 2 | Typical |
|---|---|---|---|
| | % Mass | % Mass | Product Used |
| Polyurethane dispersion | 50-80 | 60.39 | Syntegra YM |
| | | | 2000 Dow |
| | | | Chemical |
| Anhydrous Calcium | 5-30 | 15.10 | |
| Sulphate | | | |
| Titanium dioxide | 0-10 | 4.35 | |
| Antifoam agent | 1-3 | 2.05 | |
| Water | 0-10 | 5.46 | |
| Thickener | 0-3 | 0.94 | |
| Iso-propanol | 0-5 | 1.72 | |
| Epoxy resin | 1-10 | 5.00 | |
| Epoxy hardener | 1-10 | 5.00 | |

Other organic polymers dispersions, such as acrylic resin, may be added to the water-based polyurethane dispersion. It is believed that the polyurethane and the organic polymer may each be applied within a range of between approximately 5% and 75%, with the remainder being formed from the cementitious mix. It will be appreciated that the inclusion of the acrylic resin or any other organic polymer is preferable, but is not a necessary component of the Invention.

The design of the cementitious component of the composition can be varied depending upon the application under consideration. The cementitious mix may further include a combination of: high alumina cement or Portland cement; sand; aggregate; cement or concrete admixture, such as super plasticizers and accelerators; cement extenders; chemical admixtures, such as hardening, flow and quick drying agents and water scavengers; and water. However, the mixture may also include fibrous material, such as glass fibres or synthetic fibres, to increase the tensile strength of the product, and/or organic fillers, such as rubber crumb.

As mentioned, the liner is composed of different components which are mixed together before application. The water-based polyurethane dispersion (component 1) is typically placed in a container. The anhydrous calcium sulphate (component 2) is added to component 1 under continuous mixing, with a shear mixer being utilised to mix the components. After this, the epoxy resin (component 3) is added to the mixture. At least three minutes of continuous mixing is required to ensure a homogenous liquid with no visible solid particles. In instances where spraying is used for the application of the liner, the quality of the dispersion of calcium sulphate in the liquid is essential. As soon as mixing is completed, the product is ready for use and can be applied to a surface by way of brushing, rolling or spraying.

In this embodiment, all the water contained in the mixture is consumed by evaporation during and after the application and during the reaction with the cementitious material. Typically, an air powered or airless spray system is used to enable the evaporation of water in air. The high surface contact also allows the acceleration and improved efficiency of the evaporation of water. Where thicker liners (1 to 5 mm) are required, the mixture is typically sprayed or cast onto the surface, whereas where thinner liners (0.1 to 1.5 mm) are required, the mixture is typically applied to the surface by either a spray, brush or roller.

Where a shotcrete gun or a pneumatically or electrically operated spray gun is used, the product is placed in the spray container and pressure is applied on the container (typically a minimum of 5×10⁵ Pa of air pressure) to ensure proper displacement of the product through the pipes. The finest mist, which can be obtained by the spray gun, is preferably, thereby to ensure total elimination of water through evaporation before the product contacts the surface to be lined. Typically the surface to which the liner is applied is dry to the touch within 20 to 40 minutes after the application of the liner. After 24 hours the liner has cured and dried to have its final properties.

As the water reacts with the cementitious material, the polyurethane polymer coagulates and the epoxy resin and epoxy hardener reacts within a certain timeframe; the product should be used within 15 to 30 minutes of combining the different components. After this period, the application of the product becomes problematic.

The typical properties of the liner according to Example 2 is shown in Table 1 below:

TABLE 1

| Property Tested: | |
|---|---|
| Tensile strength (MPa): | 6.6 |
| Elongation @ Break (%): | 300 |
| Tear Strength (N/mm): | 18.1 |
| Hardness (Shore A): | 95 |

The properties of the liner at different % mass of the water-based polyurethane dispersion and anhydrous calcium sulphate as well as % mass of epoxy are shown in Table 2 below:

TABLE 2

| | | | |
|---|---|---|---|
| [Polyurethane dispersion + | 100 | 95 | 90 |
| Calcium sulphate] (%): | | | |
| [Epoxy] (%): | 0 | 5 | 10 |
| Tensile strength (MPa): | 9.68 | 5.44 | 4.53 |
| Elongation at break (%): | 517 | 400 | 284 |
| Adhesion on rock (visual | Poor | Good | Excellent |
| observation) | | | |

With these liners, the combination of elongation and stiffness is critical to the success of the liner in preventing rock falls or substrate damage and the ultimate collapse of the structure or mine excavation, where used as such. The dispersion provides the elastic deformation and improved tensile strength characteristics of the liner, while the cementitious mix improves the stiffness. The combination of both characteristics also provides a waterproofing and moisture barrier for the rock face or the surface of a substrate or structure.

Typical formulations of the product where used as a thin sprayed liner are provided below:

| | Typical | | | |
|---|---|---|---|---|
| | Range | Example 3 | Example 4 | Typical |
| | % Mass | % Mass | % Mass | Product Used |
| Polyurethane | 40-75 | 64.19 | 60.81 | Syntegra YM |
| dispersion | | | | 2000 Dow |
| | | | | Chemical |
| Anhydrous Calcium | 10-35 | 27.60 | 26.15 | |
| Sulphate | | | | |
| Antifoam agent | 1-3 | 1.93 | 1.82 | |
| Ethanol | 0-5 | 1.28 | 1.22 | |
| Epoxy resin | 1-10 | 2.50 | 5.00 | |
| Epoxy hardener | 1-10 | 2.50 | 5.00 | |

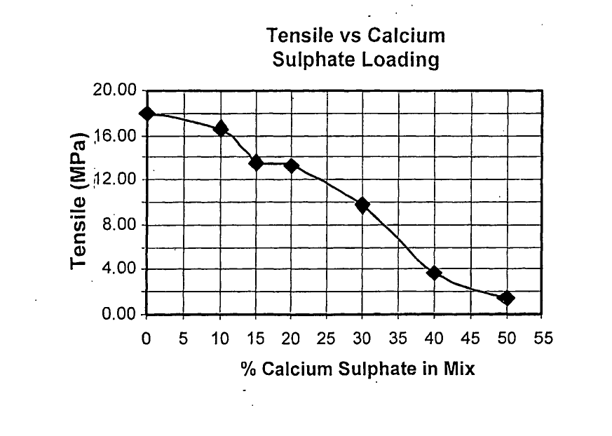

The level of anhydrous calcium sulphate in the liner affects the properties in the material, as is shown in the FIG. 1. Where the % mass of anhydrous calcium sulphate increases to a level above 30 to 35%, the properties of the liner are seriously affected.

The water-based polyurethane dispersion alone can evidently achieve an elongation of over 700% prior to failure. However, when used in combination with the cementitious material, a polymer concrete is formed of an interpenetrating network of inorganic and organic polymers, increasing the stiffness. In addition, there is the additional benefit of the water in the dispersion of polyurethane being used in the curing of the cement and the product is consequently particularly suited to the treatment of recently excavated rock structures in mining applications, most substrate surfaces and structures requiring waterproofing.

The liner is typically used as a thin spray liner (TSL) for lining excavated rock walls or stoped a mining environment. Alternatively, the liner is used in tunnel lining as a water proofing layer against water ingress of the tunnel cementitious liner. The liner may also be used to line swimming pools or dams, or may be used as a corrosion protection layer or environmental protection layer for civil structures such as bridges, dykes, weirs or the likes thereof.

1. A method of forming a liner, including the steps of mixing a water-based dispersion of polyurethane with a cementitious material to form a wet mixture and applying the wet mixture to a surface, to form the liner, wherein the % mass of the water-based dispersion of polyurethane in the wet mixture ranges between 40 and 80%.

2. The method according to claim 1, wherein the % mass of the water-based dispersion of polyurethane in the wet mixture ranges between 60 and 70%.

3. The method according to claim 1, wherein the water-based dispersion of polyurethane includes additives which improve the evaporation of the liquid of the wet mixture.

4. The method according to claim 3, wherein the additives include a low boiling point alcohol.

5. The method according to claim 4, wherein the low boiling point alcohol is isopropanol or ethanol.

6. The method according to claim 5, wherein the % mass of the additives in the wet mixture ranges between 0 to 5%.

7. The method according to claim 1, wherein the cementitious material includes anhydrous calcium sulphate.

8. The method according to claim 7, wherein the % mass of the anhydrous calcium sulphate in the wet mixture ranges between 5 and 35%.

9. The method according to claim 8, wherein the % mass of the anhydrous calcium sulphate in the wet mixture ranges between 10 and 20%.

10. The method according to claim 8, wherein the % mass of the anhydrous calcium sulphate in the wet mixture ranges between 10 and 17%.

11. The method according to claim 1, wherein an epoxy hardener and an epoxy resin from part of the wet mixture.

12. The method according to claim 11, wherein the epoxy hardener is included in the water-based dispersion of polyurethane.

13. The method according to claim 11, wherein the % mass of the epoxy hardener in the wet mixture is in the range of 1 to 10% and the % mass of the epoxy resin in the wet mixture is in the range of 1 to 10%.

14. The method according to claim 13, wherein the % mass of the epoxy hardener in the wet mixture is approximately 5% and the % mass of the epoxy resin in the wet mixture is approximately 5%.

15. The method according to claim 11, wherein the epoxy resin is mixed with a liquid carrier prior to being mixed with the epoxy hardener.

16. The method according to that claim 13, wherein the liquid carrier is an amorphous precipitated silica.

17. The method according to claim 13, wherein the mixture of the epoxy resin and the liquid carrier is in powder form and is combined with the cementitious material.

18. The method according to claim 1, wherein the wet mixture is applied to a surface by spraying, casting, rolling or brushing.

19. The method according to claim 18, wherein the wet mixture is sprayed in a fine mist onto the surface by spray gun.

20. The method according to claim 18, wherein the surface is a wall in a mine or the liner for a swimming pool or any other water proofing application and the wet mixture applied to the surface has a thickness between 0.1 to 5 mm.

21. The method according to claim 18, wherein the wet mixture applied to the surface has a thickness between 0.1 to 1.5 mm.

22. A kit for the production of a wet mixture for forming a liner, the kit including:
a first component including a water-based dispersion of polyurethane; and
a second component including a cementitious material characterised in that the % mass of the water-based dispersion of polyurethane in the wet mixture ranges between 40 and 80%.

23. The kit according to claim 22, wherein wherein the % mass of the water-based dispersion of polyurethane in the wet mixture ranges between 60 and 70%.

24. The kit according to claim 22, wherein the first component includes additives which improve the evaporation of liquid of the wet mixture.

25. The kit according to claim 24, wherein the additives include a low boiling point alcohol.

26. The kit according to claim 25, wherein the low boiling point alcohol is isopropanol or ethanol.

27. The kit according to claim 26, wherein the % mass of the additives in the mixture ranges between 0 to 5%.

28. The kit according to claim 22, wherein the second component includes anhydrous calcium sulphate.

29. The kit according to claim 28, wherein the % mass of the anhydrous calcium sulphate ranges between 5 and 35%.

30. The kit according to claim 29, wherein the % mass of the anhydrous calcium sulphate in the wet mixture ranges between 10 and 20%.

31. The kit according to claim 30, wherein the % mass of the anhydrous calcium sulphate in the wet mixture ranges between 15 and 17%.

32. The kit according to claim 22, wherein an epoxy hardener and an epoxy resin form part of the wet mixture.

33. The kit according to claim 32, wherein the epoxy hardener is included in the first component.

34. The kit according to claim 33, wherein the % mass of the epoxy hardener in the wet mixture is in the range of 1 to 10% and the % mass of the epoxy resin in the wet mixture is in the range of 1 to 10%.

35. The kit according to claim 34, wherein the % mass of the epoxy hardener in the wet mixture is approximately 5% and the % mass of the epoxy resin in the wet mixture is approximately 5%.

36. The kit according to claim 32, wherein the epoxy resin is dispersed with a quantity of liquid carrier to adsorb the liquid onto the liquid carrier.

37. The kit according to claim 36, wherein the liquid carrier is an inert fine grade of silica.

38. The kit according to claim 36, wherein the epoxy resin and liquid carrier is in powder form and is combined with the cementitious material forming the second component.

39. A wet mixture for forming a liner, the wet mixture including a water-based dispersion of polyurethane and a cementitious material, wherein the % mass of the water-based dispersion of polyurethane in the wet mixture ranges between 40 and 80%.

40. The wet mixture according to claim 39, wherein the % mass of the water-based dispersion of polyurethane in the wet mixture ranges between 60 and 70%.

41. The wet mixture according to claim 39, wherein the water-based dispersion of polyurethane includes additives which improve the evaporation of liquid of the wet mixture.

42. The wet mixture according to claim 41, wherein the additives include a low boiling point alcohol.

43. The wet mixture according to claim 42, wherein the low boiling point alcohol is isopropanol or ethanol.

44. The wet mixture according to claim 43, wherein the % mass of the additives in the mixture ranges between 0 to 5%.

45. The wet mixture according to claim 39, wherein the cementitious material includes anhydrous calcium sulphate.

46. The wet mixture according to claim 45, wherein the % mass of the anhydrous calcium sulphate in the wet mixture ranges between 5 and 35%.

47. The wet mixture according to claim 46, wherein the % mass of the anhydrous calcium sulphate in the wet mixture ranges between 10 and 20%.

48. The wet mixture according to claim 47, wherein the % mass of the anhydrous calcium sulphate in the wet mixture ranges between 10 and 20%.

49. The wet mixture according to claim 39, wherein an epoxy hardener and an epoxy resin form part of the wet mixture.

50. The wet mixture according to claim 49, wherein the epoxy hardener is included in the water-based dispersion of polyurethane.

51. The wet mixture according to claim 50, wherein the % mass of the epoxy hardener in the wet mixture is in the range of 1 to 10% and the % mass of the epoxy resin in the wet mixture is in the range of 1 to 10%.

52. The wet mixture according to claim 51, wherein the % mass of the epoxy hardener in the wet mixture is approximately 5% and the % mass of the epoxy resin in the wet mixture is approximately 5%.

53. The wet mixture according to claim 49, wherein the epoxy resin is mixed with a liquid carrier to form a powder prior to being mixed with the epoxy hardener.

54. The wet mixture according to claim 53, wherein the liquid carrier is an amorphous precipitated silica.

55. The wet mixture according to claim 53, wherein the mixture of epoxy resin and the liquid carrier is in powder form and is combined with the cementitious material.

56. A liner, including a water-based dispersion of polyurethane and a cementitious material, the % mass of the water-based dispersion of polyurethane in the liner ranges between 40 and 80% in a wet mixture of the constituents.

57. The liner according to claim 56, wherein the water-based dispersion of polyurethane includes additives which improve the setting of the liner.

58. The linear according to claim 57, wherein the additives include a low boiling point alcohol.

59. The liner according to claim 58, wherein the low boiling point alcohol is isopropanol or ethanol.

60. The liner according to any one of claim 56, wherein the cementitious material includes anhydrous calcium sulphate.

61. The liner according to claim 56, wherein an epoxy hardener and an epoxy resin form part of the liner.

62. The liner according to claim 61, wherein the epoxy hardener is included in the water-based dispersion of polyurethane.

63. The liner according to claim 61, wherein the epoxy resin is mixed with a liquid carrier to form a powder prior to being mixed with the epoxy hardener.

64. The liner according to claim 63, wherein the liquid carrier is an amorphous precipitated silica.

65. The liner according to claim 63 wherein the mixture of epoxy resin and the liquid carrier is in powder form and is combined with the cementitious material.
